(19) United States
(12) Patent Application Publication
(10) Pub. No.: US 2024/0118145 A1
(43) Pub. Date: Apr. 11, 2024

(54) Computer Implemented Method for Providing Temperature Data, a Computer Product Element and a System

(71) Applicant: ABB Schweiz AG, Baden (CH)

(72) Inventors: Joerg Gebhardt, Mainz (DE); Guruprasad Sosale, Munich (DE); Subhashish Dasgupta, Bangalore (IN); Patric Ackermann, Fischbachtal (DE); Wilhelm Daake, Petershagen (DE); Karsten Schroeder, Petershagen (DE)

(73) Assignee: ABB Schweiz AG, Baden (CH)

(21) Appl. No.: 18/479,961

(22) Filed: Oct. 3, 2023

(30) Foreign Application Priority Data
Oct. 7, 2022 (EP) 22200314.7
Oct. 26, 2022 (EP) 22203906.7

(51) Int. Cl. G01K 13/02

(52) U.S. Cl. CPC G01K 13/026

(57) ABSTRACT

A computer implemented method for determining boundary thermal resistance data of a boundary layer includes obtaining first temperature data from a first temperature sensor, which is arranged at a first pipe section; obtaining second temperature data from a second temperature sensor, which is arranged at a second pipe section, wherein the first temperature sensor is a non-invasive temperature sensor and the second temperature sensor is an invasive temperature sensor; providing process condition data; determining boundary thermal resistance data of a boundary layer of the fluid next to an inner wall of the pipe based on the process condition data.

### CROSS-REFERENCE TO RELATED APPLICATIONS

The instant application claims priority to European Patent Application Nos. 22200314.7, filed Oct. 7, 2022, and 22203906.7, filed Oct. 26, 2022, each of which is incorporated herein in its entirety by reference.

### FIELD OF THE DISCLOSURE

The present disclosure relates to computer implemented method for providing for determining boundary thermal resistance data and/or for providing temperature data of a fluid flowing through a pipe, a system for providing temperature data of a fluid flowing through a pipe and a respective computer program product.

### BACKGROUND OF THE INVENTION

Determination of temperatures are vital for safe running of facilities, as being one of the main control parameters for process control. Ensuring that temperature measurements of process media are accurate and repeatable is critical.

Traditional temperature measurement is achieved by introducing an invasive sensor, for example a thermowell, into the pipe such that a measurement is taken in the process stream. Alternately, surface temperature sensors are placed at a surface of a wall of the pipe/vessel in order to measure the temperature of this surface, and respectively determine the temperature of the medium at the other side of the wall.

Temperature is a vital parameter for the safe and efficient operation of process facilities and in many cases these technologies are insufficient to detect abnormal or hazardous circumstances. Indeed, there are many situations in reality where there are spatial inhomogeneities in the temperature field across and along the pipe/vessel. Existing state of the art invasive or non-invasive sensors will not capture these circumstances.

### BRIEF SUMMARY OF THE INVENTION

In view of the above, the present disclosure describes an improved method for determining boundary thermal resistance data and/or providing temperature data of a fluid flowing through a pipe. The present disclosure further describes a method with a more accurate boundary layer resistance calculation, in which flow data may be determined. In a general aspect, the present disclosure describes an improved method for providing temperature data of a fluid flowing through a pipe and, more particularly, a method with a more accurate boundary layer resistance calculation, in which flow data may be determined.

According to a first aspect of the present disclosure, a computer implemented method for determining boundary thermal resistance data of a boundary layer and optionally for providing temperature data of a fluid flowing through a pipe is provided: obtaining first temperature data from a first temperature sensor, which is arranged at a first pipe section; obtaining second temperature data from a second temperature sensor, which is arranged at a second pipe section, wherein the first temperature sensor is a non-invasive temperature sensor and the second temperature sensor is an invasive temperature sensor; providing process condition data; determining boundary thermal resistance data of a boundary layer of the fluid next to an inner surface of the wall of the pipe based on said process condition data; and/or based on the first temperature data and/or the second temperature data.

Optionally, determining the temperature data of the fluid based on at least the first and/or second temperature data and the boundary thermal resistance data of the boundary layer. The first and second temperature sensors are arranged spatially offset. That means the first and second temperature sensors are distanced from each other in a longitudinal and/or a circumferential direction. The first and second pipe sections describe the positions where the first and second temperature sensors are arranged.

Additionally, an ambient temperature may be provided or measured by a third temperature sensor. By taking the ambient or environmental temperature into consideration, a better measurement may be achieved.

The first and second temperature sensor are arranged on an outer surface of the wall of the pipe. The outer surface of the wall of the pipe may comprise an insulation material which is arranged around the pipe. The first and second temperature sensors can be arranged, for example, directly on the pipe or with a section extending outside the insulation material.

### BRIEF DESCRIPTION OF THE SEVERAL VIEWS OF THE DRAWING(S)

FIG. 1 is a schematic drawing of a longitudinal cut of a pipe comprising a non-invasive and an invasive temperature sensor in accordance with the disclosure.

FIG. 2 is a schematic drawing of a resistance network in a cross section of a pipe in accordance with the disclosure.

FIG. 3 is a schematic drawing of a resistance network of a pipe in accordance with the disclosure.

FIG. 4a is a flowchart of an embodiment of the method in accordance with the disclosure.

FIG. 4b is a flowchart of an alternative embodiment of a method in accordance with the disclosure.

FIG. 5 is a schematic drawing of a longitudinal cut of a pipe with a curvature in accordance with the disclosure.

FIG. 6 is a schematic drawing of a longitudinal cut of a pipe in accordance with the disclosure.

FIG. 7 is a schematic drawing of a cross section of a pipe, illustrating a resistance network in accordance with the disclosure.

FIG. 8 is a schematic drawing of a longitudinal cut of a pipe comprising a non-invasive and an invasive temperature sensor in accordance with the disclosure.

FIG. 9 is a schematic drawing of a longitudinal cut of a pipe comprising a non-invasive and an invasive temperature sensor in accordance with the disclosure.

FIG. 10 is a schematic drawing of a longitudinal cut of a pipe with a curvature comprising non-invasive and an invasive temperature sensor in accordance with the disclosure.

FIG. 11 is a schematic drawing of a longitudinal cut of a pipe comprising a non-invasive and an invasive temperature sensor in accordance with the disclosure.

FIG. 12 is a schematic flow diagram in accordance with the disclosure.

FIG. 13 is a schematic diagram relating to the correlation between the temperature and the flow in accordance with the disclosure.

FIG. 14 is another schematic diagram relating to the correlation between the temperature and the flow in accordance with the disclosure.

FIG. 15 is another schematic diagram relating to the correlation between the temperature and the flow in accordance with the disclosure.

FIG. 16 is a diagram regarding the dependence between temperature and flow regime in accordance with the disclosure.

FIG. 17 is a diagram regarding the correlation between temperature and Reynolds number in accordance with the disclosure.

FIG. 18 is a diagram regarding a predicted temperature difference and the fluid velocity in accordance with the disclosure.

FIG. 19 is a schematic drawing of a longitudinal cut of a pipe comprising a non-invasive and an invasive temperature sensor in accordance with the disclosure.

FIG. 20 is a diagram regarding the temperature difference and thermal conductivity in accordance with the disclosure.

### DETAILED DESCRIPTION OF THE INVENTION

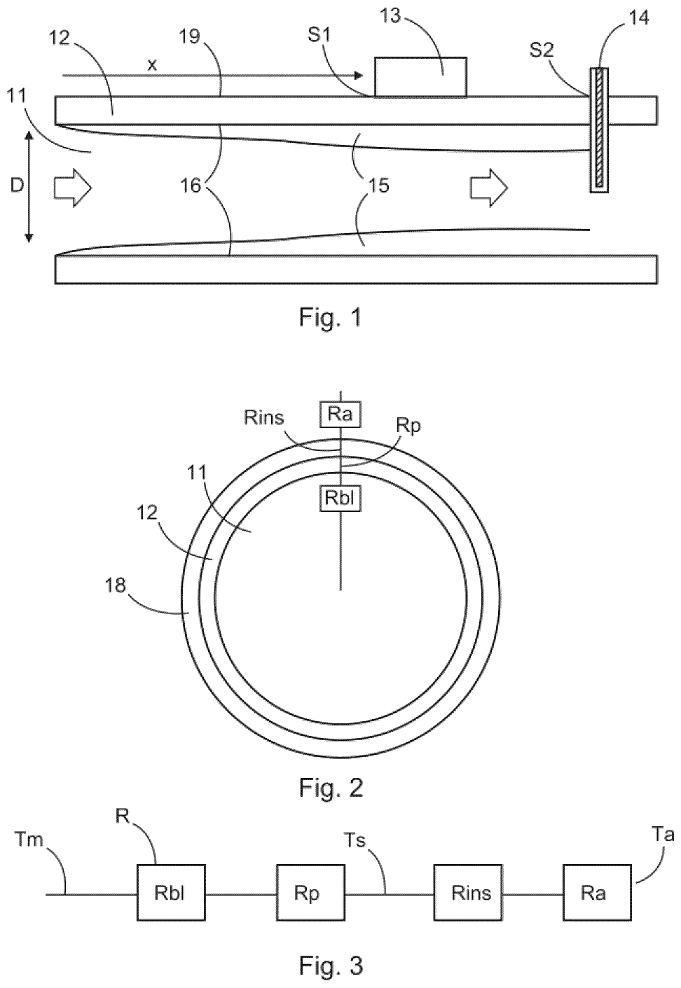

FIG. 1 shows a longitudinal cut of a pipe 12. The pipe 12 has a diameter D and a finite wall thickness. A fluid 11 flows through the pipe 12. The fluid 11 can be in liquid form or gaseous. The flow of the liquid is illustrated by the arrows.

On a first pipe section S1 a first temperature sensor 13 is arranged. The first temperature sensor 13 is a non-invasive temperature sensor. On a second pipe section S2, a second temperature sensor 14 is arranged distanced from the first temperature sensor 13. The second temperature sensor 14 is an invasive temperature sensor, for example, a thermowell. Both sensors are in direct contact with the pipe 12. Other sensor types are possible.

The first temperature sensor 13 provides first temperature data T1 and the second temperature sensor 14 provides second temperature data T2. Here the first temperature sensor 13 provides a surface temperature Ts and the second temperature sensor 14 provides an invasive temperature Tiny.

The first and second pipe sections S1, S2 describe different sections on an outer surface 19 of the wall of the pipe. The outer surface 19 of the wall of the pipe can be for example a mantel of the pipe 12 or an insulation arranged around the pipe 12.

A boundary layer 15 is located on the inner surface 16 of the pipe wall 12. The boundary layer 15 is defined as the fluid layer close to the inner surface 16 of the pipe wall 12. The boundary layer 15 is relatively slow compared to the mainstream of the fluid 11. The boundary layer 15 has a thermal boundary layer resistance Rbl. The thermal boundary layer resistance Rbl is part of a resistance network.

The resistance network connects a fluid temperature Tm with the surface temperature Ts of the outer surface of the wall of the pipe 12.

FIG. 2 shows a cross section of a pipe 12. FIG. 2 shows components of the resistance network connecting the fluid temperature Tm and a surface temperature Ts.

FIG. 3 is a schematic view of the resistance network. The resistance network comprises the pipe thermal resistance Rp and the external resistance Ra, which depends on outside conditions. The pipe 12 may be also covered with an insulation 18. Then, an additional insulation resistance Rins is added to the resistance network.

The fluid temperature Tm, which is the volume or mass average temperature of the fluid 11 is estimated by relating the surface temperature Ts to the fluid temperature Tm, via the thermal resistance network. The surface temperature Ts of the pipe 12 for a given process condition data P is dependent on thermal resistance Rbl of the boundary layer 15.

The process condition data P comprises physical data regarding the fluid and pipe parameters for determining the thermal boundary resistance Rbl. For example, nominal flow rate, pressure, density, viscosity, pipe dimensions, wall thickness and thermal conductivity.

Ts is provided by the first temperature sensor 13. Ts corresponds to the first temperature data T1. Ta is an external temperature. Ta is a reference temperature and can be measured by third sensor (not shown) or can be input into the model.

The method derives a value for the boundary layer resistance Rbl process conditions P. The boundary layer resistance Rbl is by one embodiment expressed as a function of the Reynolds number Re and the Prandtl number Pr which characterize the flow/thermal condition of the fluid. Several situations can lead to variation in boundary layer resistance Rbl without knowledge of the processing software and cause a measurement error. Factors which cause variation in boundary layer resistance, are changing flowrates or flow regimes laminar, transitional, and turbulent regimes, distance of the measurement location from the pipe inlet, upstream flow distorting features like bends, and occurrence of natural convection or buoyancy.

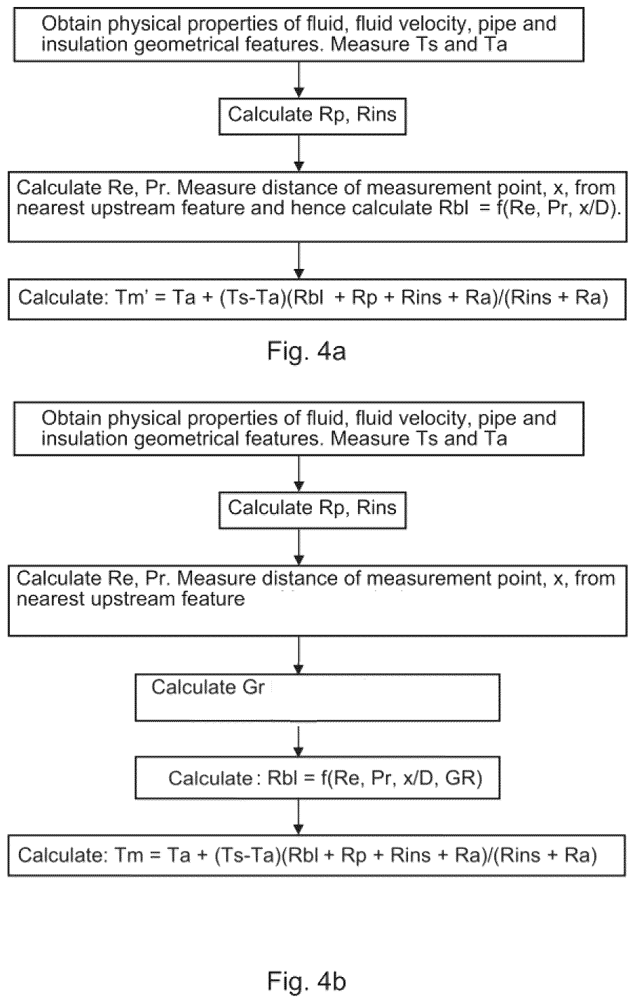

The calculation of the boundary layer resistance Rbl and the fluid temperature Tm are explained based on examples shown in FIGS. 4a and 4b.

In FIG. 4a, to estimate the fluid temperature Tm, the surface temperature Ts is measured by the first temperature sensor 13 and needs to be related to the fluid temperature Tm via the resistance network. The boundary layer 15 provides the thermal boundary resistance Rbl to transfer heat from the fluid 11 to the wall. The thermal boundary resistance Rbl needs to be accurately calculated to ensure accuracy of non-invasive temperature measurement.

At first, physical properties of the fluid are obtained. Such properties are for example fluid velocity data and pipe and/or insulation geometry data, in particular pipe diameter D. Additionally the surface temperature Ts and the external temperature Ta are measured. The surface temperature Ts can be measured for example by the first temperature sensor 13 and corresponds to the first temperature data T1.

With data based on the geometry of the pipe 12, the pipe thermal resistance Rp is calculated and, if necessary, insulation resistance Rins too.

In the next step, the Reynolds number Re and the Prandtl number Pr are calculated with the obtained data and the distance x from a nearest upstream feature to the first and/or second temperature sensor 13, 14 is measured. With this data, a boundary layer resistance Rbl can be calculated.

Rbl=f(Re,Pr,x/D) Eq. 1

The boundary layer resistance Rbl allows to calculate the temperature of the fluid Tm (see FIG. 4a).

(Tm−Ta)/(Ts−Ta)=(Rbl+Rp+Rins+Ra)/(Rins+Ra) Eq. 2

The external resistance Ra, varies often between 2 and 6 W/m2·K (for typical insulations 18 or uninsulated pipes 12). Therefore, the external resistance Ra does not impact the temperature measurement significantly, for insulated pipes 12. The insulation resistance Rins is calculated by using the insulation dimensions and thermal conductivity of the insulation 18.

Calculation of the boundary layer resistance Rbl involves calculation of the Reynolds number Re which requires fluid velocity data, density data, viscosity data and pipe diameter data. Fluid velocity data is preferably obtained by measuring. Density and viscosity data are either measured or obtained from knowledge of the fluid 11. The Reynolds number Re is given as:

(density*velocity*pipe diameter)/dynamic viscosity Eq. 3

The Calculation of the boundary layer resistance Rbl also requires the Prandtl number Pr. Calculation of the Prandtl number Pr requires the physical properties of the fluid, the thermal conductivity, the specific heat capacity and the viscosity data, often influenced as such by local temperature. The Prandtl number Pr is given by:

(dynamic viscosity*specific heat capacity)/thermal conductivity Eq. 4

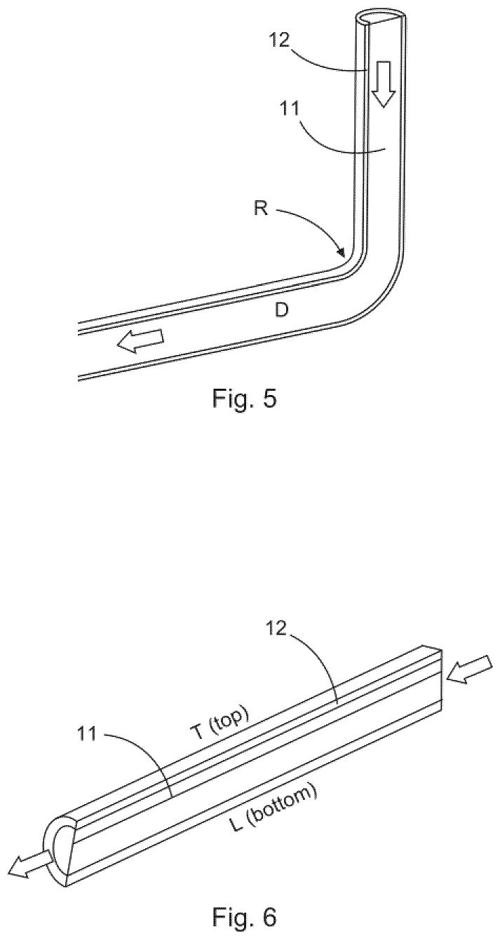

The boundary layer resistance Rbl also possibly includes the Grashof number Gr or any number which accounts for natural convection or buoyancy effects leading to flow/thermal stratification across the transverse pipe cross section (see FIG. 5b). The Grashof number Gr is calculated based on the fluid properties.

Rbl=f(Re,Pr,x/D,Gr) Eq. 5

FIG. 5, shows a pipe 12 with an upstream curvature with a radius R. The pipe 12 has the diameter D.

FIG. 6 shows a longitudinal section of the pipe 12. The pipe 12 comprises a top and bottom section.

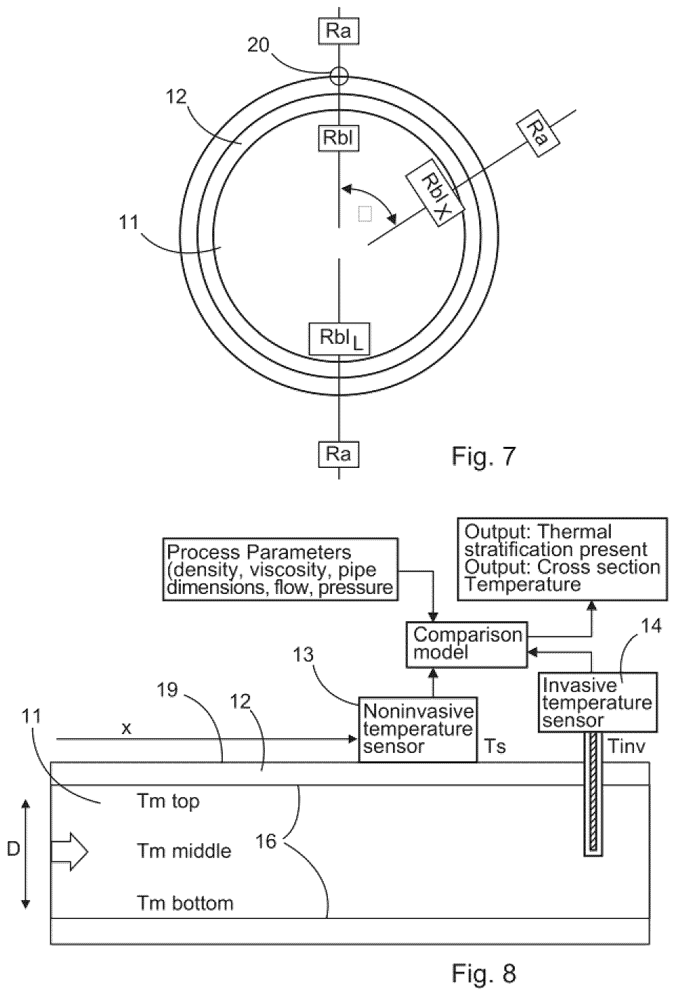

FIG. 7 shows a cross section of the pipe 12 according to FIG. 6. The boundary layer resistance Rbl in this embodiment includes a parameter accounting for circumferential variation in fluid/thermal conditions due to natural convection or buoyancy effects. Such a parameter is provided by the process condition data P. Here, a reference point 20 is set, so the boundary layer resistance Rbl at any circumferential location can be expressed in terms of an angle φ and incorporated into the method.

Rbl=f(Re,Pr,x/D,Gr,D/2R,φ) Eq. 6

The dependency of boundary layer resistance Rbl on y can be, for example, determined by a computational fluid dynamics calculation.

In FIG. 8, the first temperature 13 sensor is arranged on the pipe 12, upstream from the second temperature sensor 14. The pipe 12 is preferably non-vertical or essentially horizontal. The first temperature sensor 13 measures the surface temperature Ts of the pipe 12. Ts corresponds to the first temperature data T1.

The second temperature sensor 14 is an invasive temperature sensor. The second temperature sensor 14 is arranged downstream from the first temperature sensor 13. The second (invasive) temperature 14 sensor here is used to determine an invasive temperature Tiny. The invasive temperature Tiny corresponds to the second temperature data T2.

This embodiment comprises as input the process condition data P or process parameters like density, viscosity, pipe dimensions, velocity and pressure and the surface temperature and the invasive temperature Tiny. This data is input into the comparison model to calculate a predicted surface temperature Tsp. The difference between the surface temperature Ts and the predicted surface temperature Tsp is used to determine flow data F, here in particular flow state data or stratification data. The comparison model also allows to determine a temperature cross section. In other words, it allows to determine the fluid temperature Tm at the top, middle and bottom of the pipe 12. In a stratified flow, the fluid temperature Tm at the top, middle and bottom are different from each other.

The presence or probability of a stratification can be output in the form of an alarm. The temperature distribution across the pipe 12 is provided as an output using several variables for lower, middle, and top temperature. To re-iterate, the model ensures that the process condition data (Nominal flow rate, pressure, density, viscosity, pipe dimensions, wall thickness and thermal conductivity of the fluid) are either input as stationary nominal parameters or even as inputs from real sensors in the vicinity and are taken into consideration.

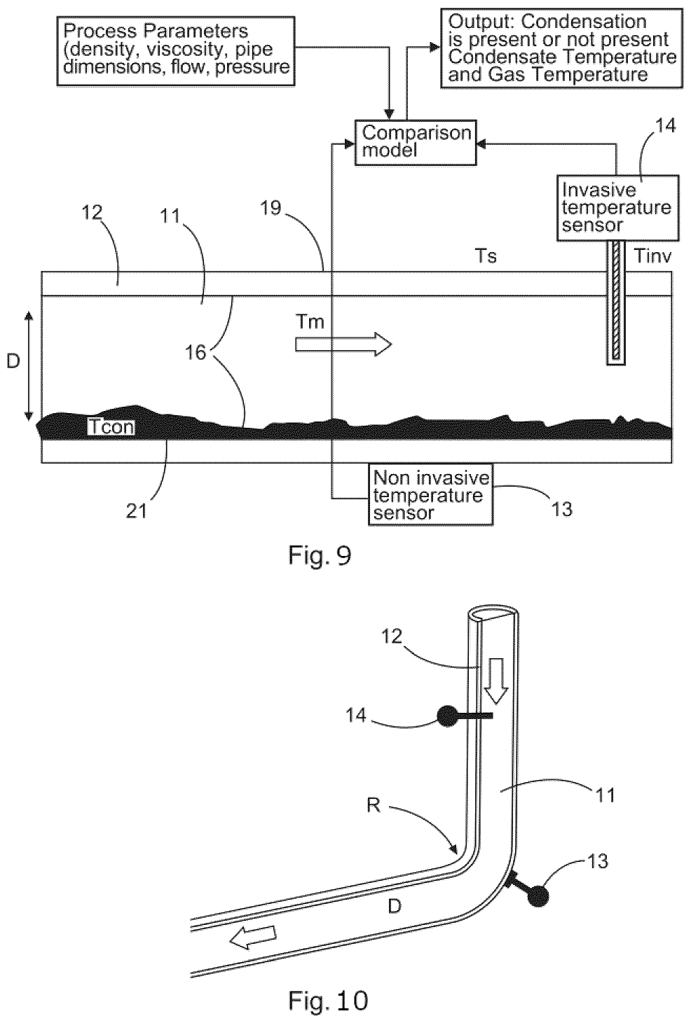

As shown in FIG. 9, the first temperature sensor 13 for measuring the surface temperature Ts of the pipe 12 is placed upstream of the second temperature sensor 14. Alternatively, the first temperature sensor 13 can also be placed downstream or at the same axial position the second temperature sensor 14. The second temperature sensor 14 is an invasive temperature sensor. The fluid 11 in this embodiment is gaseous.

The non-invasive first temperature sensor 13 is positioned in circumferentially opposite position of the invasive second temperature sensor 14. Preferably on a position where a condensate 21 collection is most likely to occur. This can easily be determined by persons skilled in the art. For example, the surface sensor on an essentially horizontal pipe 12 should be mounted on or close to the lower end of the pipe 12. This embodiment is advantageous for steam measurement. Other uses are possible.

In FIG. 9, the measured data of the invasive second temperature sensor 14 and input process condition data P are used to predict the surface temperature Ts of the pipe 12. The measurement of the invasive second temperature sensor 14 represents the fluid temperature Tm in the bulk of the gas stream. The difference between the surface temperature Ts and the predicted temperature Tsp is used in the comparison model to determine the existence of condensate 21 in the pipe 12 as well as the temperature of the fluid 11 and the possible condensate temperature Tcon.

For a bend as shown in FIG. 10, the sensor is mounted on or close to the outer side. Process condition data P (nominal flow rate, pressure, density, viscosity, pipe dimensions, wall thickness and thermal conductivity of the fluid) are either input as stationary nominal parameters or as inputs from sensors.

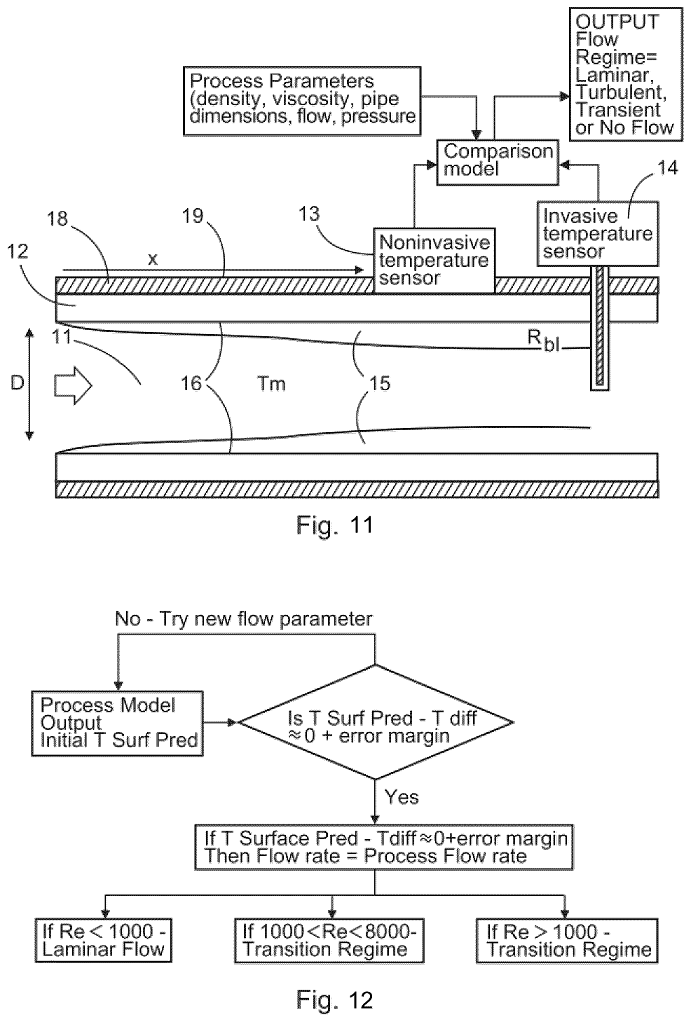

FIG. 11 is similar to FIG. 8. Contrary to FIG. 8, FIG. 11 comprises an insulation 18 arranged around the pipe 12. The first temperature sensor 13 is arranged on the pipe 12. In other words, the first temperature sensor 13 is partially enclosed by the insulation 18 and in direct contact with the mantle of the pipe 12. In the embodiment according to FIG. 11, the presence of stratification or low flow is measured. The same embodiment as in FIG. 11 can be used to measure flow regime data, whether the flow in the pipe 12 is laminar, transient or in a turbulent regime.

For this reason, the difference between the measured invasive temperature Tiny, the predicted surface temperature Tsp based on the comparison model and the true surface temperature Ts is used to determine the flow regime.

The advantage of this embodiment is that the comparison model for predicting the fluid temperature Tm provides a flow-dependent temperature difference between an invasive measurement and the surface.

FIG. 12 shows an iterative estimation process whereby the estimated flow rate is calculated, and the flow regime determined by calculating the Reynolds number Re using the pipe parameter and process condition data P. The process or comparison model predicts a surface temperature Tsp based on a flow parameter. The predicted surface temperature is compared to a difference of the measured temperatures Tdiff. If the difference of the predicted surface temperature Tsp and the difference temperature Tdiff is around zero and in an error margin, the flow rate equals the process flow rate, else the flow parameter gets amended and the process starts again. Based on Reynolds number Re, it can be concluded if it is a laminar, transitional, or turbulent flow regime.

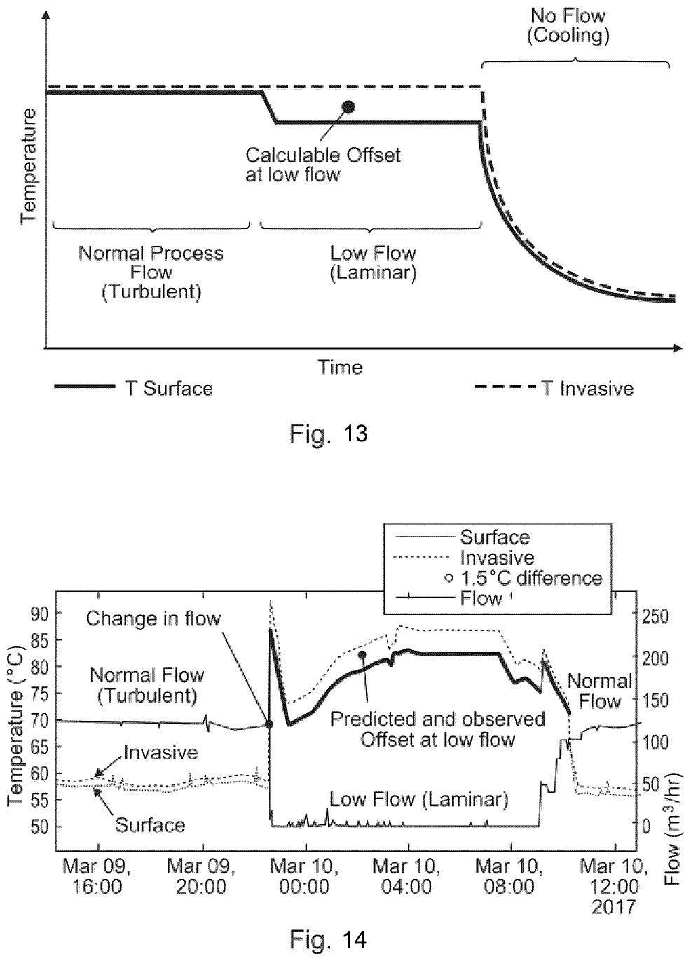

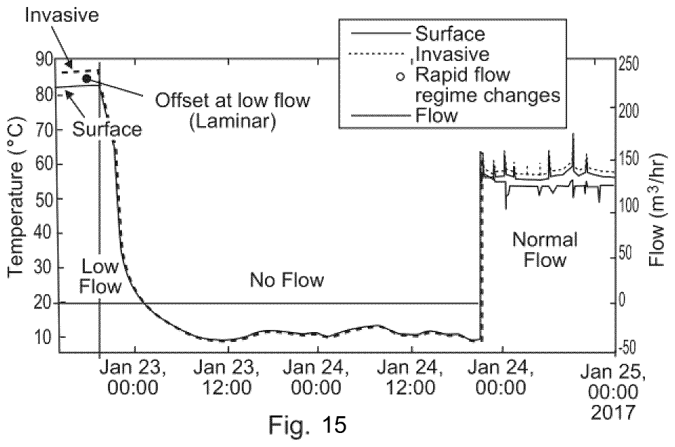

FIG. 13, FIG. 14 and FIG. 15 show practical examples of the output of such a sensor combination in a real process environment with a time series data set.

FIG. 13 illustrates the temperatures during the transitions from a normal process flow (turbulent) to a low flow regime (laminar) and from a low flow to a no flow (cooling) regime. FIG. 14 illustrates the temperatures in a transition from a normal flow to a low flow regime and back to a normal flow regime. FIG. 15 illustrates the temperature behaviour during a transition from a low flow to a no flow regime and from a no flow to a normal flow regime.

Under normal (turbulent) flow conditions, the predicted measurements and the surface measurements match the criteria for turbulent flow (validated by a flow meter). During a low flow regime, the temperature of both the invasive and non-invasive measurement do not cool down but follow with an offset or a larger difference. At a later stage both invasive and surface cool at relatively the same rates and with a significantly reduced separation indicating a true no flow regime.

In other words, during a low flow regime, the surface and invasive temperature show a larger difference than during a normal flow regime. Using this, the flow regime can be derived from the surface and invasive temperature.

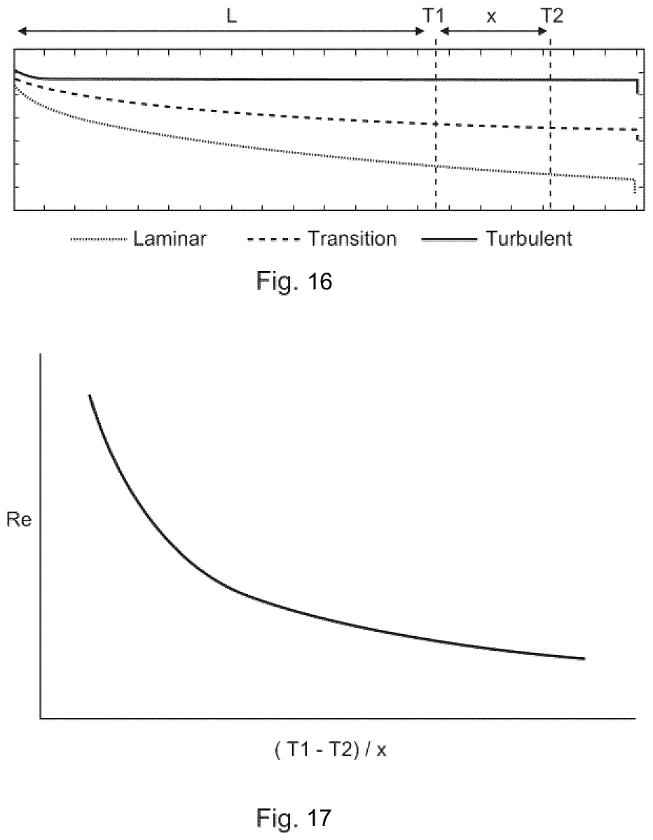

In FIGS. 16 and 17, first and second temperature data or pipe surface temperatures T1 and T2 are measured by the first and second temperature sensors 13, 14 at points separated by distance x. Corresponding to first and second temperature data T1−T2 or ΔT the Reynolds number Re is obtained from the relation between Re and ΔT. The boundary layer resistance Rbl is modified accordingly, and the fluid temperature Tm calculated using equation 2.

The same embodiment shown in FIG. 11 can also be used to predict or measure flow rates of gas flows. For flowing gases, the boundary layer resistance Rbl is influenced by the flow rate with the difference between the surface temperature Ts and bulk fluid temperature Tm being significant at low flow rates. For an additional input into the model in such cases would be the pressure either as a nominal parameter or as a variable from an existing measurement. The knowledge of the pressure can significantly increase the accuracy of the measurement. A further embodiment may introduce a known thermal insulation 18 around the measurement with a known thermal resistance Rins to increase the accuracy.

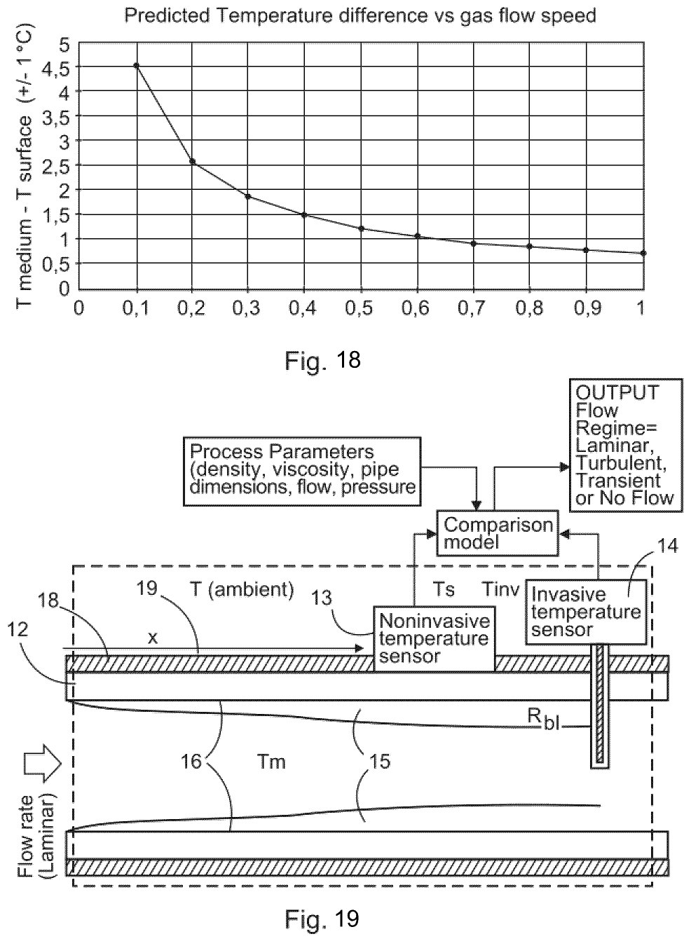

FIG. 18 shows the relation between a predicted temperature difference and a flow speed of the fluid, in particular a gas. The difference decreases with a growing flow speed.

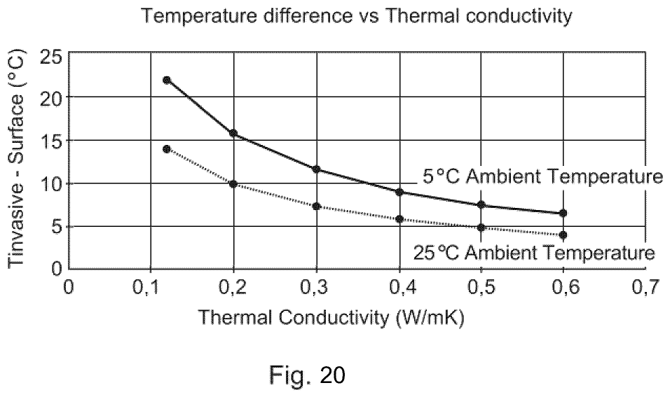

In a further embodiment according to FIG. 19, the real time measurement of thermal conductivity of liquids is solved. The embodiment corresponds in structure to the embodiment according to FIG. 11. This embodiment ensures an in-situ measurement unlike existing viscometers or ultrasonic non-contact measurements. In such an embodiment, the flow of the fluid 11 in the horizontal pipe 12 is ensured to be slow enough to ensure laminar flow. The outer surface 19 of the wall of the pipe 12 is insulated with a known insulation 18. The boundary layer resistance Rbl and hence the corresponding difference between the surface temperature Ts and the invasive measurement Tiny is dependent on the thermal conductivity of the fluid 11. The measured difference between the invasive temperature Tiny and surface temperature Ts in a steady state, laminar flow rate (with all other factors known) will indicate the thermal conductivity of the fluid 11 as shown in FIG. 20.

In an alternate embodiment, the ambient temperature can be controlled to ensure a significant temperature difference between the fluid 11 and the ambient. Preferably, the measurement of the surface temperature Ts should be as accurate as possible. This is possible with reasonably insulated and carefully installed cable thermometers. Also, temperatures should not be higher than approximately 100° C.

The present disclosure has been described in conjunction with exemplary preferred embodiments. However, other variations can be understood and effected by those persons skilled in the art and practicing the claimed invention, from the studies of the drawings, this disclosure, and the claims. Notably the steps presented can be performed in any order, i.e., the present invention is not limited to a specific order of these steps. Moreover, it is also not required that the different steps are performed at a certain place or at one node of a distributed system, i.e., each of the steps may be performed at different nodes using different equipment/data processing units.

In the claims as well as in the description the word “comprising” does not exclude other elements or steps and the indefinite article “a” or “an” does not exclude a plurality. A single element or other unit may fulfil the functions of several entities or items recited in the claims. The mere fact that certain measures are recited in the mutual different dependent claims does not indicate that a combination of these measures cannot be used in an advantageous implementation.

### REFERENCE SIGNS

S1 first pipe section
S2 second pipe section
Tm fluid temperature data
T1 first temperature data
T2 second temperature data
Ts surface temperature
Tsp predicted surface temperature
Tinv invasive temperature
Tcon condensate temperature
P process condition data
Rbl thermal boundary resistance data
Rp pipe resistance
Rins insulation resistance
Ra external resistance
10 system
11 fluid
12 pipe
13 first temperature sensor
14 second temperature sensor
15 boundary layer
16 inner surface of the wall
18 insulation
19 outer surface of the wall
20 reference point
21 condensate

According to a first aspect of the present disclosure, a computer implemented method for determining boundary thermal resistance data of a boundary layer and optionally for providing temperature data of a fluid flowing through a pipe is provided: obtaining first temperature data from a first temperature sensor, which is arranged at a first pipe section; obtaining second temperature data from a second temperature sensor, which is arranged at a second pipe section, wherein the first temperature sensor is a non-invasive temperature sensor and the second temperature sensor is an invasive temperature sensor; providing process condition data; determining boundary thermal resistance data of a boundary layer of the fluid next to an inner surface of the wall of the pipe based on said process condition data; and/or based on the first temperature data and/or the second temperature data; optionally, determining the temperature data of the fluid based on at least the first and/or second temperature data and the boundary thermal resistance data of the boundary layer. The first and second temperature sensors are arranged spatially offset. That means the first and second temperature sensors are distanced from each other in a longitudinal and/or a circumferential direction. The first and second pipe sections describe the positions where the first and second temperature sensors are arranged.

Additionally, an ambient temperature may be provided or measured by a third temperature sensor. By taking the ambient or environmental temperature into consideration, a better measurement may be achieved.

The first and second temperature sensor are arranged on an outer surface of the wall of the pipe. The outer surface of the wall of the pipe may comprise an insulation material which is arranged around the pipe. The first and second temperature sensors can be arranged, for example, directly on the pipe or with a section extending outside the insulation material.

The first temperature data may comprise data of the surface temperature of the pipe and the second temperature data may comprise data of the temperature of the fluid inside the pipe. The type of data provided depends on the used sensor type.

The boundary layer can be described as the layer of the fluid, which is next to the inner surface of the wall of the pipe. The stream of the boundary layer is relatively slow compared to the mainstream fluid. This layer has its own thermal resistance and contributes to the difference in temperature between the bulk temperature of the flowing fluid and the wall temperature.

Accuracy of measurement depends especially on a correct estimation of the boundary layer resistance. The boundary layer resistance is the thermal resistance of the fluid layer next to the inner surface of the wall of the pipe and is an important component in the overall thermal resistance network connecting the surface temperature and the fluid temperature. Variation in boundary layer resistance, due to flow regime changes, distance of measurement point from the pipe inlet, upstream flow distorting features and natural convection or buoyancy effects causes drifts in the measured temperature.

The method comprises a prediction and/or comparison model, wherein a surface temperature may be predicted and compared to a measured surface temperature. The predicted surface temperature and the measured surface temperature may be based on the first and second temperature data. More precisely, the first temperature sensor provides a measured surface temperature, and the second temperature sensor is used to predict the surface temperature. It may be also possible, that the comparison model uses a nominal temperature as reference or to predict a surface temperature. A difference from the prediction can be used to determine both the presence of stratification and the temperature distribution.

The process condition data can comprise nominal process conditions. The process condition data comprises data necessary for calculating or estimating the thermal resistance of the boundary layer and subsequently the temperature of the fluid inside the pipe. The process condition data is also used to determine flow data. The process condition data can be input manually or provided by further sensors. It is also possible that corresponding calculations are carried out offline.

A possible embodiment comprises determining flow data of the fluid based on a comparison model using the first and second temperature data and the process condition data.

The flow data can include flow state data and/or a flow regime data and/or stratification data and/or flow allocation data. Flow state data comprises information whether a stratification is present. Flow regime data comprises information if the flow is turbulent transitional or laminar. Flow allocation data indicates if there are any build-ups or allocations inside the pipe, for example crystallization and condensation build-ups. Flow data also includes if there is any concentration of product constituents.

According to a further embodiment, the process condition data comprise distance data of the first temperature sensor and/or the second temperature sensor to a reference point, in particular to a feature of the pipe. Such a feature can be an inlet or a bending of the pipe.

According to another embodiment, the process condition data comprise flow velocity data, viscosity data, density data and pipe diameter data. With this data, the Reynolds number may be calculated. The Reynolds number helps predicting flow patterns in different fluid flow situations.

According to a further embodiment, the process condition data comprise viscosity data, thermal conductivity data and specific heat capacity data of the fluid. Based on these data the Prandtl number may be calculated. The Prandtl number is defined as the ratio of momentum diffusivity to thermal diffusivity.

The Reynolds number, the Prandtl number and the distance data of the temperature sensors are advantageous to determine or estimate a precise value of the thermal resistance of the boundary layer. In other words, the thermal resistance of the boundary layer depends at least on the Reynolds number, the Prandtl number and the distance of the temperature sensor to a reference point.

In another embodiment, the process condition data comprise curvature radius data and diameter data of the pipe. A bend with a curvature with a radius R is a flow disturbance and the curvature data is therefore advantageous for determining flow data. The curvature data and the diameter data are also further factors for determining a precise value of the resistance of the boundary layer.

According to an embodiment, the process condition data comprise pressure data and/or the pipe material data and/or wall thickness data. These data help to estimate a more precise value for the resistance of the boundary layer. These data can be measured or input manually.

According to an embodiment, a thermal resistance network is determined; wherein the thermal resistance network comprises external thermal resistance data, insulation thermal resistance data, pipe thermal resistance data and the boundary thermal resistance data. The boundary thermal resistance is preferably estimated according to one of the methods above. The remaining resistances are for example measured, known, or calculated.

According to a further embodiment, a surface temperature is predicted based on the first temperature data; and the difference between the predicted surface temperature and the measured surface temperature based on the second temperature data is used to determine the flow state, in particular whether a stratification is present.

For example, at least one sensor measures the surface temperature of the pipe and is placed upstream or downstream of the invasive temperature measurement on a non-vertical or often essentially horizontal piece of the piping. Key process parameters (e.g., nominal flow rate, pressure, density, viscosity, pipe dimensions, wall thickness and thermal conductivity of the fluid) are either input as stationary nominal parameters or even as inputs from real sensors in the vicinity. The invasive temperature measurement is used in the model to predict the surface temperature. The difference between the measured surface temperature and the predicted temperature can be used to determine the flow state or whether a stratification circumstance is present. The presence or probability of a stratified state can be output in the form of an alarm. The temperature distribution across the piping is provided as an output using several variables for lower, middle, and top temperature.

In a further embodiment, the non-invasive first temperature sensor is positioned circumferentially offset to the invasive second temperature sensor; wherein a surface temperature is predicted based on the second temperature data and a difference from the measured surface temperature of the first temperature sensor, and the predicted surface temperature can be used to determine an allocation of condensate, crystallization and/or other build-ups.

In this embodiment, for example, at least one sensor that measures the surface temperature of the pipe is placed upstream or downstream of an invasive temperature sensor or at the same axial position as an invasive temperature sensor. The non-invasive sensor is positioned circumferentially in a position where a condensate collection is most likely to occur. For example, the surface sensor on an essentially horizontal pipe should be mounted on or close to the lower end of the pipe. For a bend, the sensor is mounted on or close to the outer side. process condition data (e.g., nominal flow rate, pressure, density, viscosity, pipe dimensions, wall thickness and thermal conductivity of the fluid) are either input as stationary nominal parameters or read from real sensors in the vicinity. The invasive temperature sensor data and input process condition data are used to predict an expected surface temperature of the pipe. The invasive temperature sensor data represents the temperature in the bulk of the fluid stream. The difference between the surface sensor and the prediction is used to determine the existence of condensate. The process temperature comparison model provides a flow dependent difference in temperature between an invasive measurement and the surface. Without such a correlation with a model confidently detecting condensate build up would not be possible.

According to an embodiment, the second temperature data provides a predicted surface temperature and a measured invasive temperature, wherein the difference between the measured invasive and measured surface temperature is based on the first and second temperature data, and the predicted surface temperature is used to determine the flow regime, in particular whether a turbulent, transitional, or laminar flow regime is present.

In other words, the difference between the measured invasive temperature, the predicted surface temperature from a comparison model and the true surface temperature can be used to determine the flow regime through an iterative estimation process, according to which the estimated flow rate is calculated, and the regime determined by calculating the Reynolds number using the nominal pipe and process parameters.

An aspect of the invention comprises a computer program product, which, when executed on computing devices of a computing environment, is configured to carry out the steps of the method according to one of the above embodiments.

Another aspect of the invention comprises a system for providing temperature data of a fluid flowing through a pipe, the system comprising: a first temperature sensor for providing first temperature data, which is thermally coupled to a first pipe section; a second temperature sensor for providing second temperature data, which is thermally coupled to a second pipe section; wherein the first temperature sensor is a non-invasive temperature sensor and the second temperature sensor is an invasive temperature sensor; the system comprises a processing unit configured to determine the temperature data of the fluid on the basis of at least the first and/or second temperature data and the boundary thermal resistance data of the boundary layer; and to determine flow data of the fluid based a comparison model using at least the first and second temperature data and the process condition data.

Another aspect of the invention is the use of a method according to one of the embodiments above for providing thermal conductivity data, in particular thermal conductivity data of the fluid.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer implemented method for determining boundary thermal resistance data of a boundary layer, comprising:
obtaining first temperature data from a first temperature sensor, the first temperature sensor being arranged at a first pipe section;
obtaining second temperature data from a second temperature sensor, the second temperature sensor arranged at a second pipe section;
wherein the first temperature sensor is a non-invasive temperature sensor, and the second temperature sensor is an invasive temperature sensor;
providing process condition data; and
determining boundary thermal resistance data of a boundary layer of the fluid next to an inner surface of the wall of the pipe based on at least one of: the process condition data, the first temperature data, and the second temperature data.

2. The method according to claim 1, wherein determining the temperature data of the fluid based on at least the first and/or second temperature data and the boundary thermal resistance data of the boundary layer.

3. The method according to claim 1, wherein determining flow data of the fluid based on a comparison model using the first and second temperature data and the process condition data.

4. The method according to claim 1, the flow data comprises flow state data and/or flow regime data and/or stratification data and/or allocation data.

5. The method according to claim 1, wherein the process condition data comprises distance data of the first temperature sensor and/or second temperature sensor to a reference point.

6. The method according to claim 5, wherein the reference point is a feature of the pipe.

7. The method according to claim 6, wherein the feature of the pipe is an inlet of the pipe.

8. The method according to claim 1, wherein the process condition data comprises flow velocity data, viscosity data and density data of the fluid and pipe diameter data.

9. The method according to claim 1, wherein the process condition data comprises viscosity data, thermal conductivity data and specific heat capacity data of the fluid.

10. The method according to claim 1, wherein the process condition data comprises curvature radius data and diameter data of the pipe.

11. The method according to claim 1, wherein the process condition data comprises pressure data and/or the pipe material data and/or wall thickness data.

12. The method according to claim 1, further comprising determining a thermal resistance network; wherein the thermal resistance network comprises external thermal resistance data, insulation thermal resistance data, pipe thermal resistance data and the boundary thermal resistance data.

13. The method according to claim 1, wherein a surface temperature is predicted based on the first temperature data and a difference between the predicted surface temperature and the measured surface temperature based on the second temperature data is used to determine the flow state, in particular whether a stratification is present.

14. The method according to claim 1, wherein the non-invasive first temperature sensor is positioned circumferentially offset from the invasive second temperature sensor; and wherein a surface temperature is predicted based on the second temperature data and a difference from the measured surface temperature of the first temperature sensor and the predicted surface temperature, which are used to determine an allocation of condensate, crystallization and/or other buildups.

15. The method according to claim 1, wherein the second temperature data provides a predicted surface temperature and a measured invasive temperature, and wherein the difference between the measured invasive temperature and the measured surface temperature based on the first and second temperature data and the predicted surface temperature is used to determine the flow regime, in particular whether a turbulent, transitional or laminar flow regime is present.

16. A system for providing temperature data of a fluid flowing through a pipe, the system comprising:
a first temperature sensor disposed to provide first temperature data, the first temperature data being thermally coupled to a first pipe section;
a second temperature sensor disposed to provide second temperature data, the second temperature data being thermally coupled to a second pipe section;
wherein the first temperature sensor is a non-invasive temperature sensor and the second temperature sensor is an invasive temperature sensor;
a processing unit configured to:
determine the temperature data of the fluid based on at least one of the first temperature data and the second temperature data, and further based on the boundary thermal resistance data of the boundary layer; and
determine flow data of the fluid based on a comparison model using the first temperature data, the second temperature data, and the process condition data.

17. The system according to claim 16, wherein determining flow data of the fluid based on a comparison model using the first and second temperature data and the process condition data.

18. The system according to claim 16, the flow data comprises flow state data and/or flow regime data and/or stratification data and/or allocation data.

19. The system according to claim 16, wherein the process condition data comprises distance data of the first temperature sensor and/or second temperature sensor to a reference point.

20. The system according to claim 19, wherein the reference point is a feature of the pipe.
